(19) United States
(12) Patent Application Publication
(10) Pub. No.: US 2003/0018745 A1
(43) Pub. Date: Jan. 23, 2003

(54) System and method for creating and distributing virtual cable systems

(76) Inventors: Jim McGowan, Dix Hills, NY (US); Mark Dresner, Dix Hills, NY (US); Brian O'Rourke, New York, NY (US)

Correspondence Address: SCULLY, SCOTT, MURPHY & PRESSER, 400 Garden City Plaza, Garden City, NY, 11530, US

(21) Appl. No.: 10/176,469

(22) Filed: Jun. 20, 2002

Related U.S. Application Data
(60) Provisional application No. 60/299,519, filed on Jun. 20, 2001.

(51) Int. Cl. G06F 15/16; H04N 7/173; G06F 17/00

(52) U.S. Cl. 709/217; 707/104.1; 725/125

(57) ABSTRACT

A system and method for creating and distributing virtual channels of digital video content. Initially, a first entity is enabled to acquire digital video content from one or more sources and store the digital video content into a database storage device. Next, the first entity is enabled to select digital video content and group the selected digital video content to form virtual specialty channels, each virtual specialty channel having content customized for a particular viewer base. The created virtual specialty channels are stored in the database storage device which is accessible by a second entity over a public communications network. The second entity comprises infrastructure for delivering virtual specialty channels to individual viewers over a broadband communications channel. The second entity receives a webcast of the virtual specialty channels, and the second entity distributes one or more virtual specialty channels to individual viewers over a broadband communications channel, where they are received by viewer television devices. Viewer interactivity is enhanced as interactive links may be embedded in the video content by the first and second entities with the links displayed on the television. The links are selectable by viewers, and when selected, a viewer is enabled to interact with third entities via their associated television set-top box and over the public communications network.

### CROSS-REFERENCE TO RELATED APPLICATION

This application is based on and claims the benefit of the filing of U.S. Provisional Patent Application No. 60/299,519 filed Jun. 20, 2001 entitled “VIRTUAL CABLE SYSTEMS”, the contents and disclosure of which are fully incorporated herein by reference.

### BACKGROUND OF THE INVENTION

1. Field of the Invention

The present application relates to the information systems such as cable television networks, their operators and distributors, and particularly to a new system and method for creating and distributing information, e.g., television programming, utilizing and incorporating digital television system and World Wide Web (WWW) facilities in order to provide interactive television using broadband distribution.

2. Discussion of the Prior Art

Basic cable television systems, networks and providers, are at the threshold of providing interactive capabilities that would enable viewers to engage in e-commerce, to request video-on-demand (VOD), or to view supplemental video content. However, such cable television systems have heretofore not been able to fully capitalize on the advantages of newer technologies such as digital television and world-wide-web (broadband) distribution. What is needed is a comprehensive system and method that would enable the custom-crafting of the various interactive content targeted for specific audiences, and further a business flow model that supports the acquisition, physical integration, and custom distribution of these interactive content components.

What is further needed is a comprehensive system and method that enables the custom-crafting of interactive content and programming targeted for specific audiences over broadband infrastructures, and further one that exploits the digital television technology.

### SUMMARY OF THE INVENTION

The system, methodology and business flow model of the invention, referred to herein as Virtual Cable Systems (VCS), provides unique interactive capabilities that enable television viewers to engage in e-commerce, to request video-on-demand (VOD), or to view supplemental video content. All this interactive content may be custom-crafted for specific audiences (viewer base). That is, the VCS includes a business flow infrastructure supporting the acquisition, physical integration, and custom distribution of these interactive content components.

In one aspect of the invention, VCS is a process implemented for defining and distributing virtual cable television systems. These systems are entire collections of channels complete with interactive features including e-commerce. More particularly, VCS represents the entire business process and hardware infrastructure for securing video content from the full spectrum of content providers; “Channelizing” that content into specialty channels (such as “French Cooking” or, “Grand Canyon Tours”); packaging collections of these channels into virtual cable systems appealing to diverse consumer groups (e.g., a Culinary System providing multiple channels of cooking, wine and culinary topics); digitizing all this content for storage and distribution over the WWW; merging this primary content with other video providing both advertising and links to the WWW for e-commerce; scheduling the webcasting of each channel over the WWW; recording viewer usage and interaction using a unique display/presentation layout; enabling a viewer's interactive requests to see secondary video or to conduct e-commerce; and, storing viewer usage and purchasing information for eventual data mining, subject to privacy controls individually selected by each viewer.

VCS exploits contemporary digital television technology to provide content deliverable and viewable cable television systems. Its open-ended design is such that readily permits the adaptation of new features and opportunities. For example, as digital television technology advances, VCS may adapt to exploit the new features and opportunities to interact with the viewing public. For example, with regard to technical infrastructure, VCS exploits new technologies, such as MPEG-4, to provide advanced consumer services, such as rapid video on demand, VOD.

Furthermore, VCS leverages the database and e-commerce capabilities of the WWW with the vast reachable audience of cable television. The VCS enables television viewers to access customized regions of the WWW. These viewers have the freedom to view dedicated programming and to individually select advertising and e-commerce opportunities.

Thus, according to the principles of the invention, there is provided a system and method for creating and distributing virtual channels of digital video content. Initially, a first entity is enabled to acquire digital video content from one or more sources and store the digital video content into a database storage device. Next, the first entity is enabled to select digital video content and group the selected digital video content to form virtual specialty channels, each virtual specialty channel having content customized for a particular viewer base. The created virtual specialty channels are stored in the database storage device which is accessible by a second entity over a public communications network. The second entity comprises infrastructure for delivering virtual specialty channels to individual viewers over a broadband communications channel. The second entity receives a webcast of the virtual specialty channels, and the second entity distributes one or more virtual specialty channels to individual viewers over a broadband communications channel, where they are received by viewer television devices. Viewer interactivity is enhanced as interactive links may be embedded in the video content by the first and second entities with the links displayed on the television. The links are selectable by viewers, and when selected, a viewer is enabled to interact with third entities via their associated television set-top box and over the public communications network.

Advantageously, VCS builds on the base of technology provided by the contemporary digital television industry and the World-Wide-Web (WWW), and beyond its unique exploitation of existing technology, VCS may readily adapt to incorporate value-added components, processes, and ideas.

### BRIEF DESCRIPTION OF THE DRAWINGS

Further features, aspects and advantages of the apparatus and methods of the present invention will become better understood with regard to the following description, appended claims, and the accompanying drawings where:

FIG. 1 illustrates an overview of the VCS of the present invention;

FIG. 2 provides details of the Acceptance Process performed by a VCS operator according to the present invention;

FIG. 3 is a flow chart depicting the details of the “channelization” process 150;

FIG. 4 depicts the VCS distribution process 200;

FIG. 5 is a flow chart depicting the details of the processing 300 occurring at the Viewer's home;

FIG. 6 illustrates the basic information flow and business processes of the VCS; and,

FIG. 7 depicts an exemplary VCS screen 600 presented on a digital television or like television receiver.

### DETAILED DESCRIPTION OF THE PREFERRED EMBODIMENTS

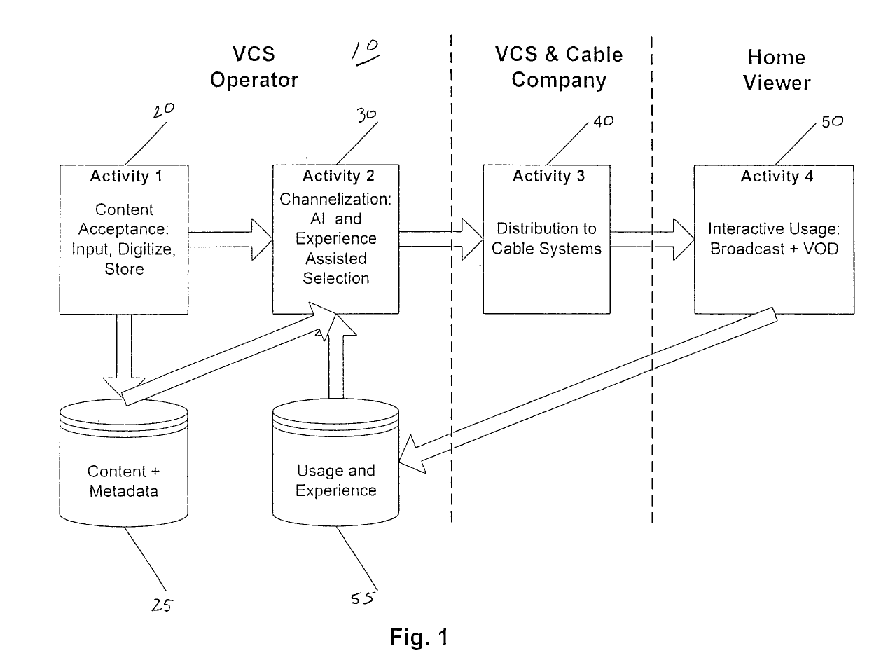

An overview of the Virtual Cable System (VCS) 10 of the present invention is shown in FIG. 1. In the concept illustrated in FIG. 1, there exists four (4) primary activities that together constitute the VCS business and technical process: a first activity 20 and second activity 30 that are performed by a VCS operator, which comprises a business enterprise functioning to acquire and “channelize” video media content; a third activity 40 which comprises the cooperation of the VCS operator, e.g., a business enterprise, and, potentially an associated business party, e.g., a cable television company who is responsible for providing the physical broadband access to individual customers for the VCS operator; and, a fourth activity 50 representing the function of the ultimate target of the VCS business process, the home television viewer and that viewer's set-top box that accepts the incoming broadband feed, separates out the VCS digital feed, separates the individual channels, and enables the viewer to see them.

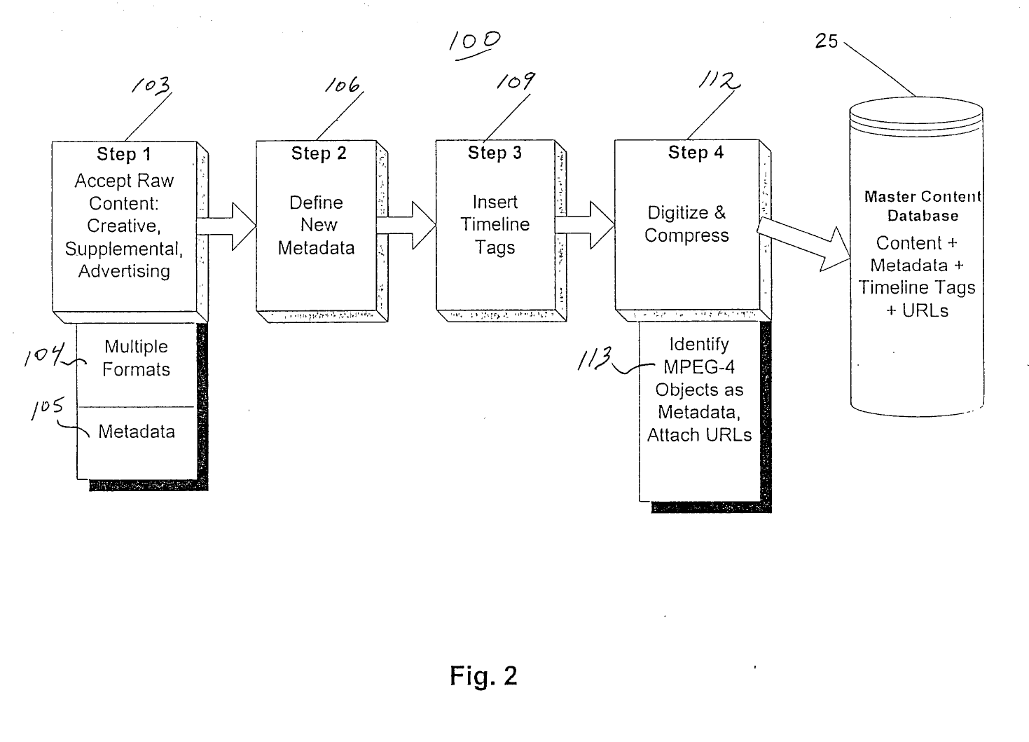

With respect to the first activity 20 of the VCE system 10, the VCS operator may be a separate business, a cable television system, an advertising agency, a university, or a private individual. This VCS operator may solicit video media content from a variety of sources: individual content creators, advertising firms, network libraries, or internal sources. For example, a cable television company may be a VCS operator and may desire to form a library of video content for distribution over customized-channels. When video content arrives at the VCS operator site, an Acceptance Process is performed, the details of which will be described in greater detail herein with respect to FIG. 2. The accepted incoming video content is logged, with the video content including an associated metadata portion. Metadata includes text (hard or soft copy), descriptions of the content in addition to any legal and contractual documentation, terms and conditions for use, and any other material deemed necessary by either the VCS operator or the content provider. As shown as the concluding part of the first activity 20 of FIG. 1 is the digitization of the content and its storage in a database. Digitization will be accomplished using contemporary hardware and software systems, as may be known and used among skilled artisans. Digitized content may be in MPEG-2 format or, will take advantage of the available, MPEG-4 format. It should be understood that the video content may be supplied to the VCS operator already in digitized format or, the VCS operator may perform this activity as part of a fee-based arrangement. The content, plus digitized versions of all metadata, will be stored in an object-oriented database 25 as depicted in FIG. 1, and may constitute a database system such as Cache'® available from InterSystems Corporation, or like database system. An object-oriented database, not a relational database, is preferred because the contents to be stored will have highly diverse, dynamic schema requirements. Different types of content or content from different providers will have distinctly different metadata requirements. After initial creation, the database will be subject to continuous upgrade to meet these requirement changes. A baseline database may be initially provided to each VCS operator, but individual VCS operators may evolve their own distinct database structures.

With respect to the second activity 30 of the VCE system 10, the accepted content stored in the database 25 may be recalled, reviewed and ultimately selected for packaging into new channels of information. This “channelization” is accomplished using an interactive, object-based software tool. Creation of the channel includes integration of secondary content, such a commercials or tags to enable e-commerce. Once individual channels have been constructed, they may be grouped into entire virtual cable systems, i.e., with each of the channels and the assembled cable system physically existing in a database attached to the WWW.

The third activity 40 of the VCE system 10 represents the joint or cooperative activity of the VCS operator and an associated business party. For purposes of discussion, FIG. 1 assumes a cable television company, for example, is the associated party, however, the primary requirement for the associated party is the physical ability to provide broadband access to individual customers for the VCS operator.

The fourth activity 50 of the VCE system represents the ultimate target of the VCS business process. Preferably, the ultimate target is a home television viewer owning a contemporary set-top box that is designed to accept the incoming broadband feed, separate out the VCS digital feed, separate out the individual channels, and enable the viewer to see them. Each channel supplied by VCS may include some interactive content, which the television viewer may engage. The set-top box particularly is designed to recognize all interactive action. Contemporary set-top boxes include both hardware and software (operating system “OS” and middleware) components to enable interactivity. The VCS operator will supply application layer programs to complete the support of interactivity.

Preferably, the user interactive actions are sent back upstream, over the physical medium providing broadband access, and appropriate actions are taken, including triggering of e-commerce or selection of VOD. All these interactive actions are captured as data in a second major object-oriented database, the Usage and Experience Database 55, such as shown in FIG. 1.

Over time, this growing Experience Database 55 will provide significant, valuable insight to content creators, advertisers, cable systems and other business parties. With many viewers of VCS material, there is provided a significant sample size for demographics analysis and pattern recognition. The rights to view and act on this data will be the subject of separate business contracts between the VCS operator and other parties.

FIG. 2 is a flow chart depicting the details of the Acceptance Process 100 of the first activity. As shown in FIG. 2, the first principal step 103 in the business process is the acceptance of raw content. For purposes of discussion, content includes both the “creative” pieces to be considered as the primary program material and all the supplementary content including advertising videos, additional videos providing detailed information, e.g., to be viewed with picture-in-picture (PIP) technology, and links to the WWW for e-commerce or other purposes. It is understood that the incoming content may be in any standard format 104, including already digitized and compressed formats such as in accordance with the MPEG-2 standard. The content provider will include relevant metadata 105: description of the contents, legal and business documents, restrictions on usability, or other matters deemed relevant or appropriate. Eventually all metadata will be saved in digital format in the Master Content Database 25 as described with respect to FIG. 1.

Returning to FIG. 2, step 106, represents an optional step in the VCS process, which is directed to the creation of additional metadata. For example, the VCS operator may have employees scan the content and characterize that content with additional keywords. This new metadata will be entered in the Master Content Database 25. In a third step 109, the primary content video will have tags inserted along the timeline. Standard video processing software products, such as QuickTime 5 Pro® available from Apple Computer, Inc. is capable of providing time tags every 5.0 seconds or, with any other selected granularity. These tags will be available for subsequent integration with interactive content, such as advertising. This step means that the VCS operator can time the appearance on the viewer's screen of advertising content on a 5-second incremental basis. In a further step 112, the video content is digitized and compressed.

In the preferred embodiment, the system may initially employ MPEG-2 compression. However, as MPEG-4 hardware and software systems are now becoming available, they will be utilized as MPEG-4 compression schemes render the content more readily suited for VOD, i.e., the much smaller MPEG-4 file sizes make distribution of longer content (e.g., greater than 30.0 minutes in viewing time) which is most practical from a time and cost standpoint for both the VCS operator and the home viewer. MPEG-4 processing will additionally permit the creation of additional metadata. As shown at 113, FIG. 2, under MPEG-4, individual objects in the video content may be identified and assigned a URL tag. The VCS operator will assign URL tags to objects of interest throughout the content. For example, a video showing a commercial product—e.g., a can of Pepsi®—may have the can assigned a URL. In subsequent interactivity, a viewer clicking on that object will be directed to that VCS-defined URL; this URL may in turn enable redirection to alternative interactive content. In this example, that content could be a commercial for that product, e.g., Pepsi®, the ability to buy that product using e-commerce mechanisms, a video on this history of that product, or whatever association the VCS operator chooses to make for the URL. Further, these URL redirections may change during the course of the program. For example, clicking on the object representing a commercial product may trigger different interactivity responses at different points during the program. With this MPEG-4 mechanism, interactive content, such as advertising, will be able to appear dynamically and opportunistically. Many more responses and interactive functionality are envisioned that fall within the scope of the invention and which may be based on the 5-second or greater increment timeline buried in the video.

When material has been stored in the Master Content Database 25, it is available for use as VOD. The underlying business practices, including subscription information and authorization to view material, is currently supported by standard software and business-related systems that execute on computers. The owners and operators of those systems may be the VCS operator or an associated business partner.

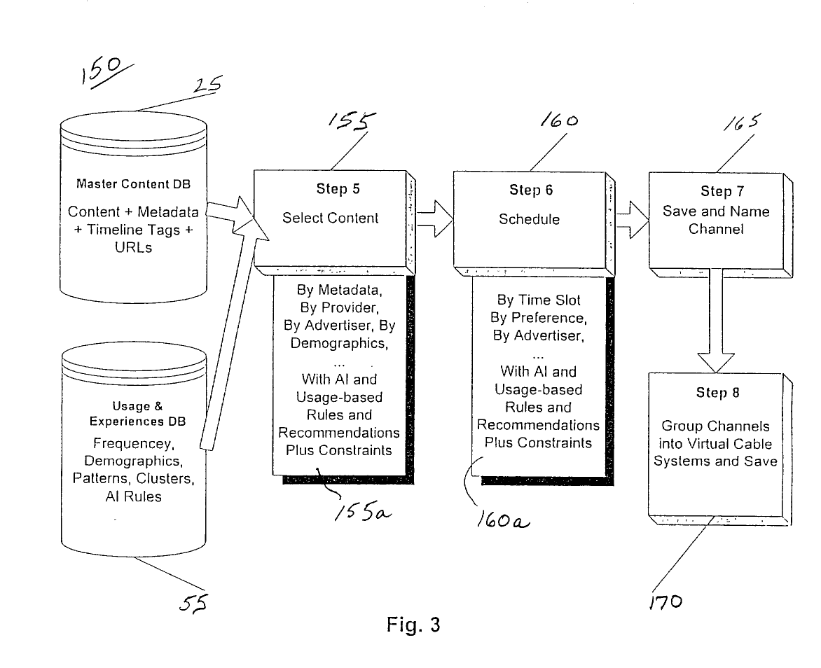

FIG. 3 is a flow chart depicting the details of the “channelization” process 150. Channelization requires a first step 155 of selecting content for a virtual channel, and then scheduling the broadcast of content at step 160. To facilitate channelization, VCS preferably implements an interactive, object-based software interface for the selection and scheduling process. Such an user interface may incorporate aspects of the iCanSP™ suite of products available from iCanSP, a Computer Associates Company. A drag-and-drop methodology may conveniently enable lists of candidate programs to be generated and then individual programs selected for a given channel. As referred to herein, a “channel” in the VCS, is a bundled collection of content, which is stored on a server and released to the WWW on a scheduled basis. The VCS operator, content provider, cable system, advertisers, or other key business partners are the entities that decide what a channel should be and how many channels there should be. For example, a content provider may be considering the release of a new cable television channel. For the purposes of test marketing, the new content provider may assemble representative programming for this channel, provide the content to a VCS operator, and have the VCS operator make this “test” channel available over the WWW for test marketing purposes, including gathering history of interactivity to provide demographic information and responses to alterative advertising concepts.

In further regard to the selection step 155, the VCS system of the invention enables sophisticated selection of content from the Master Content Database 25. As shown as step 155a, content may be searched for on the basis of metadata: by type of content, by advertiser specifications, by content provider, demographics, etc. The VCS additionally provides assistance in the selection process using artificial intelligence (AI) rules and recommendations. The Usage and Experience Database 55 constructed from viewer interactive requests and actions forms the basis for developing the AI routines. Well-known clustering algorithms, including fuzzy clustering techniques, and pattern recognition routines are implemented to isolate key trends and findings. This data is converted into rules that assist—or simply offer recommendation—in the selection of content for each channel. While contemporary network programming efforts are based on demographic and other analyses, the extremely large sample size and history of interactivity provided by VCS enables a much more refined, sophisticated approach in the selection process. For example, in creating a channel of cooking programs, prior data in the Usage and Experience Database 55 may suggest demographics patterns to stress or to avoid in choosing content. Thus, a rule may comprise a demographic pattern, for instance, only distribute Spanish speaking video content in predominantly Spanish neighborhoods. The AI interface additionally functions to suggest, but not control the process of content selection.

Referring back to the channelization process 150, scheduling step 160 performs the scheduling of content. The user interface will enable programs to be scheduled in a variety of patterns: one time slot at time, automatic filling of a block of time with programs all from one source, and automatic repeating of content on standardized bases. For example, a single action could enable an entire collection of cooking programs from one provider to be shown each night at 7 PM Eastern Time, with a 2 AM repeat. Step 160a describes the steps of scheduling which also include scheduling by preference, or by advertiser.

It should be understood that selection of content specifically requires that a channel be specified in terms of primary content, however, secondary content may also be selected. For example, all the advertising video to accompany one program may additionally be selected. The selection and scheduling of secondary content is performed using the same interactive drag-and-drop software tool. To increase selection efficiency, the selection of primary and secondary content may be conducted in parallel. As shown at step 160a, the AI tool provides suggestions for matching primary and secondary content. Further, the interactive tool respect business rules embedded in the metadata. For example, a particular program may have constraints on when and where it can be shown, or it may have restrictions on what kinds of advertisers may be allowed to display interactive content. A business rule to this effect would be embedded in the metadata.

Referring back to the channelization process 150 of FIG. 3, a next step 165 represents the notation and storage of the relationships between selected primary and secondary content in the Master Content Database 25. Specifications noted and saved include programs selected, scheduling, and all secondary content such as advertising. After channels have been defined, a further step 170 requires the bundling of groups of channels into virtual cable systems (VCSs). The aforementioned interactive, drag-and-drop software tool will enable these groupings to be made. Preferably, AI algorithms may be implemented to guide the groupings based on data in the Usage and Experience Database 55.

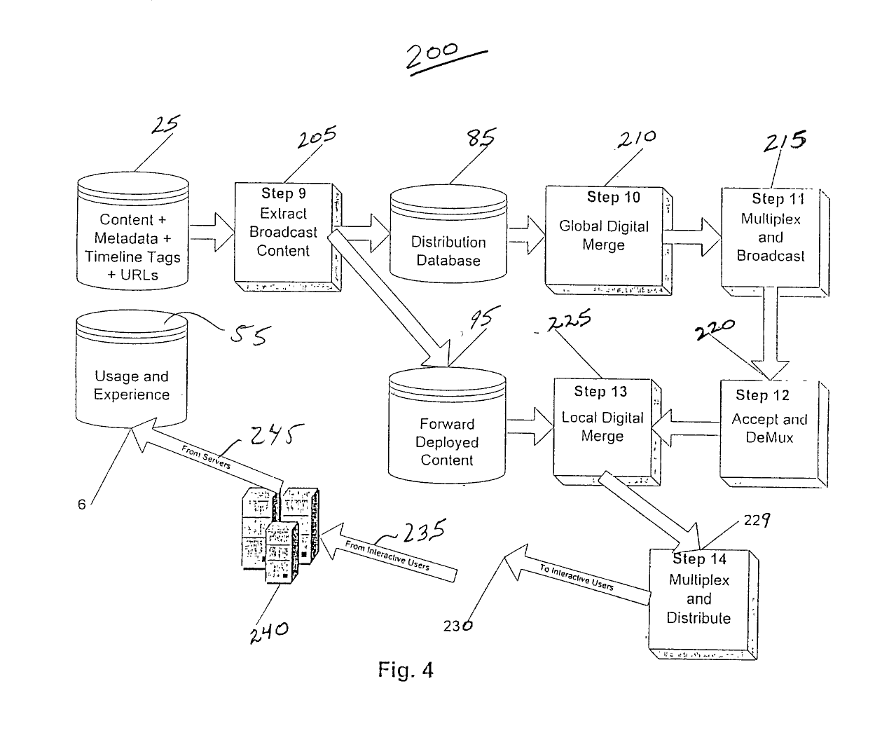

Following the channelization and specification of each VCS, a distribution process 200 is required which is now described with respect to FIG. 4. While the Master Content Database 25 includes a variety of data and is used for general storage and channelization activity, a separate database is preferred for the content actually intended for distribution over the WWW. This separate database, referred to in FIG. 4 as Distribution Database 85, is provided for reasons of: risk management and processing efficiency. Thus, as indicated at a first step 205, the actual content to be broadcast is extracted from the master database 25 and placed into the Distribution Database 85. The Distribution Database will then comprise content plus minimum metadata such as scheduling information. In addition to the Distribution Database 85 which is maintained by the VCS operator, additional databases for storing content may be placed at key locations, such as the head end of cable television companies serving as the broadband distributor for VCS. One such additional database is referred to as the Forward Deployed Content 95, as shown in FIG. 4, which also receives actual content to be broadcast extracted from the master database 25 to enable a level of customization above the current “local inserts into network feeds” technology. In the case where the same secondary content is to be shown everywhere, for example the same Pepsi® advertisement must be provided to every viewer of a particular program, then the advertisement can be merged digitally into the primary program content before the webcasting.

FIG. 4, at step 210 illustrates the performance of global mergers, e.g., merging of global advertisements with content programs. Merging uses the 5.0 second increment timeline or, the object-oriented methodology of MPEG-4 which, according to the MPEG-4 standard, already has timelines embedded therein. The merged video content is then multiplexed and distributed out over the WWW, as indicated at step 215. While connected to the WWW, via a standard web-browser interface, participating business partners (PBP) may receive these webcasts, as indicated 220. These participating business partners may be cable television companies, national level telephone companies, regional telephone companies, or any other enterprise able to provide broadband access to individual homes and businesses.

After receiving the VCS signal, the PBP will demultiplex them and then perform local merger of content, as indicated at step 225, using content from the Forward Deployed Content Database 95. That database may include content already downloaded in advance from the VCS operator as shown in FIG. 4. Alternatively, the PBP may have interactive content of their own that they desire to merge into programs. The hardware and software architecture for providing VCS provides no technical barrier to multiple sources for the Forward Deployed Database 95. The advantage of having the content downloaded by the VCS operator is that the burden and effort to select and schedule this content is then on the VCS operator, not the PBP. A PBP, e.g., a small cable company, may desire the sophistication that this feature offers but may not have the company infrastructure to economically implement the feature.

The Forward Deployed Content Database 95 enables specification of interactive content. For example, a local cable company could insert advertising videos that target specific zip codes or even individual homes. VCS implements the software tools to assist this merging process, including the management of bandwidth restrictions. For example, a local cable company may not have the bandwidth to support customization down to the individual household level.

It should be understood that the entire distribution and merging process, depicted in FIG. 4, steps 205-225 is not a real-time process. Preferably, these steps are performed ahead of the ultimate “broadcast” time, for reduced risk, when the individual viewer expects to view the program.

As a final step 229, indicated in FIG. 4, the PBP functions to re-multiplex the VCS channels, now including all secondary content, and broadcast them to the interactive users. Because of the bandwidth requirements, it is intended that broadcasting be over a broadband channel 230.

FIG. 4 illustrates other features integral to the VCS process: first, there is depicted interactive requests/responses 235 from viewers of VCS that are transmitted back from each viewer's home. This back channel communication, requiring very low bandwidth, will arrive at a server site 240. In the example where the PBP is a cable television company, this site would comprise the head end for the cable company. Such companies already have a cluster of servers to receive and act on these interactive requests. Alternatively, the servers could be located at a facility maintained by the VCS operator. These servers particularly enable interactive requests, submitted by a viewer of a VCS channel, to be completed. These actions include e-commerce, VOD, or connecting to an information site on the WWW. Second, the servers pass on key data 245 for each interactive request to the Usage and Experience Database 55 maintained by the VCS operator.

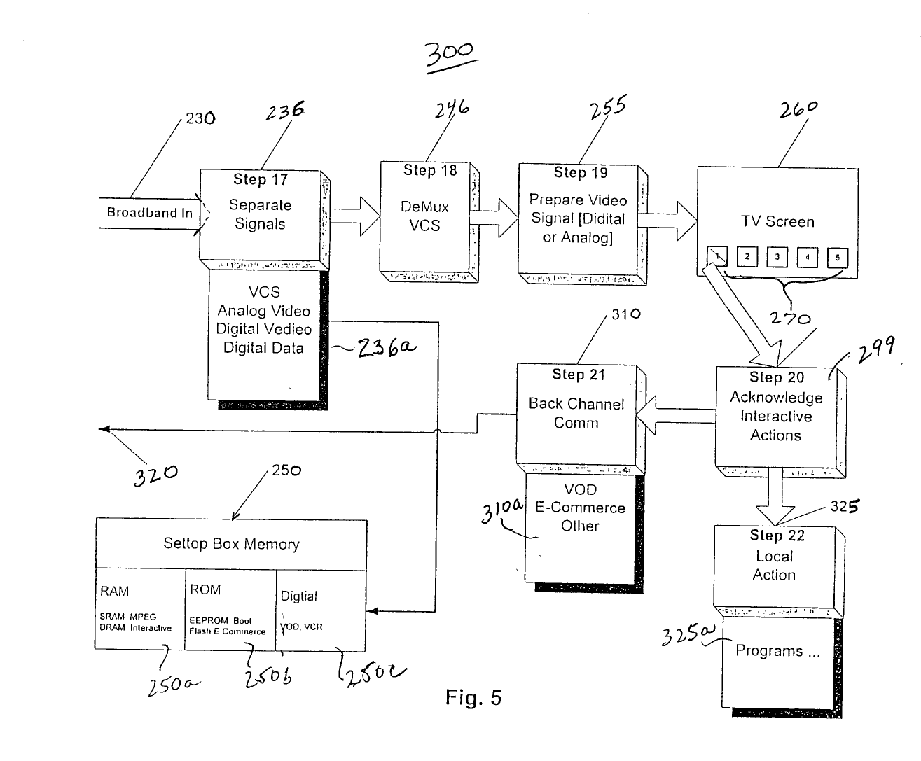

FIG. 5 is a flow chart depicting the details of the processing 300 occurring at the Viewer's home according to the fourth activity. As shown in FIG. 5, the broadband signal 230 broadcast from the PBP is received at the viewer's home, or location. As indicated at step 236, a set-top box 250 associated with the viewer's television receiver receives the broadband stream 230 and separates out different signals 236a, which as shown in FIG. 5, includes analog video, digital video and digital data. Skilled artisans will appreciate that the set-top box 250 includes a variety of processing and data storage capability to support all needed functionality, including RAM, RAM memory, 250a, 250b and digital VOD processing 250c, etc., and complies with all current architectural standards as specified by entities such as the Advanced Television Systems Committee (ATSC) and Advanced TV Enhancement Forum (ATVEF). The incoming broadband signal 230 may contain a variety of information. Besides the VCS signal, analog and digital video may be present and pure digital data—potentially from the WWW—may also be included. The set-top box 250 will first separate out the VCS signal, and, at step 246, demultiplex it. Depending upon the type of television set the viewer has, the set-top box then constructs an appropriate video signal for each of the VCS channels, as indicated at step 255. Each VCS channel is selectable, just like regular cable channels, using the set-top box and its remote control. When the viewer selects a VCS channel, the television, depicted conceptually as block 260 in FIG. 5, displays a large viewing area supplemented by small selectable objects 270, that appear as smaller unobtrusive icons on the bottom of the television screen display that are selectable by the viewer for enabling interactive television. The television presents the selected primary video content for the VCS channel on a continuous basis, and that primary content will dominate the TV screen display. Using either a set-top box remote or, a cordless keyboard, the television viewer is able to navigate the icons 270 and make selections. In response to selection of an interactive icon, acknowledgement and action taken as depicted at step 299. A selection may, for example, trigger a PIP display of video, the download of VOD for later viewing, an e-commerce interaction, or other WWW connection. As shown in FIG. 5, the set-top boxes are designed to include digital storage 250c capable of supporting the reception and eventual playback of VOD.

As further shown in FIG. 5, interactivity may require some form of back channel communication, as indicated at step 310. For example, an e-commerce transaction 310a will necessitate communication 320 with servers 240 at some remote location. Alternatively, the interactive response may be satisfied with some local action, as indicated at step 325. For example, the interactive request may be for supplemental video content that has already been loaded into and stored in the set-top box memory 250. Programs 325a resident in the user's set-top box may be implemented for performing any local processing.

Having described the components of the VCS infrastructure, it is understood that VCS is a technology that enables the construction and presentation of entire virtual cable systems. That is, VCS is not a single video channel, nor, is it simply another pathway to the WWW. These VCS systems consist of multiple video channels that are stored on the WWW and requested by the viewer via that viewer's television set—not a computer—to view any of the VCS channels. These channels are “normal” in the sense that they are broadcast via VCS on a regular, scheduled basis.

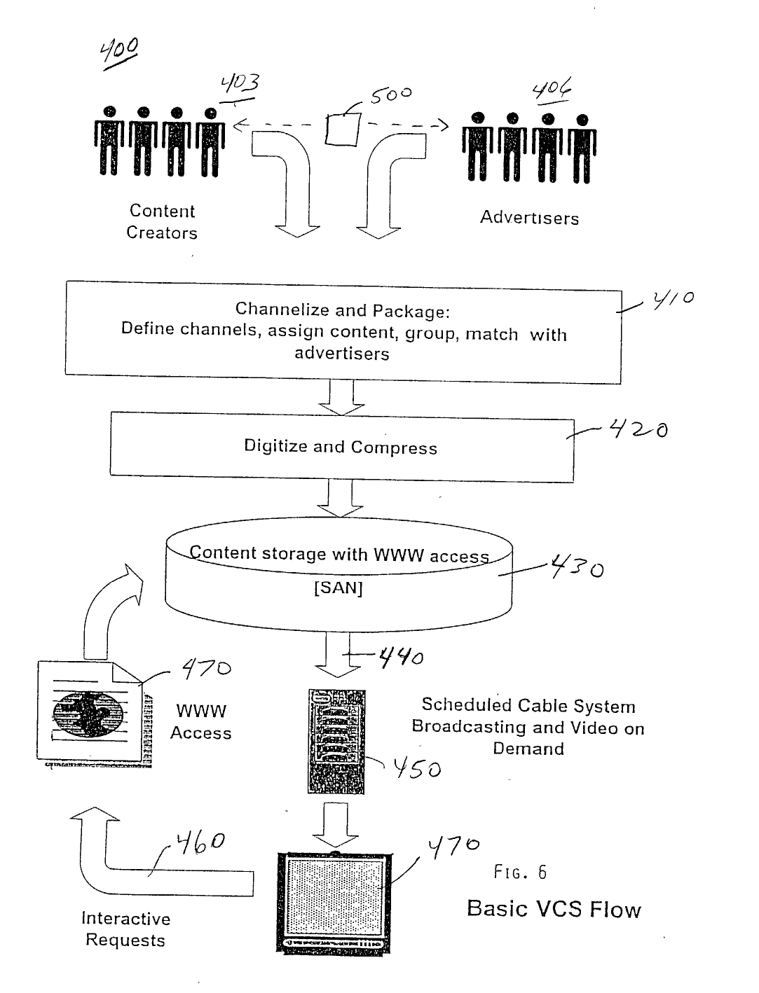

FIG. 6 illustrates the basic information flow and business processes 400 of the VCS. Initially, content creators 403 and advertisers 406 are contacted by a VCS operator 500. There is an abundance of content creators seeking access to cable systems, while cable systems are themselves limited in the channels they have available. At the same time, advertisers are seeking avenues that have proven power to reach an audience and trigger commerce. The VCS operator contacts content creators and advertisers, seeking all forms of material and advertising. Working together, the material is “channelized” 410 with channels defined according to the type and quantity of content obtained. Potential advertisers will be targeted to specific channels or programs. Additionally, the channels are grouped or “packaged” into virtual cable systems. For example, various cooking channels may be grouped into a the Culinary Cable System. Viewers of cable television systems are thus offered the ability to buy VCS programming by selecting one or more of these virtual systems.

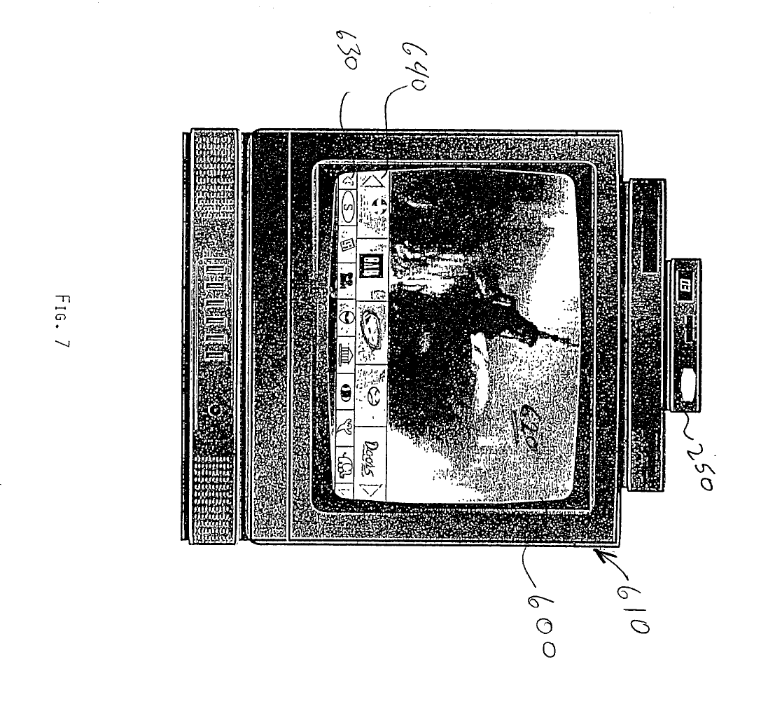

After this creative and business process 410 of defining channels and packages, the next step 420 is preparation of the material for Internet distribution. The video content is thus digitized and compressed for storage 430 on mass storage systems in communication with and connected to the Internet. Current technology such as a Storage Area Network, SAN, can provide the necessary speed and capacity. The VCS operator then distributes the programming via current cable television firms. Each participating cable company thus assigns part of its broadband spectrum for VCS channels. The VCS portion of the cable signal coming into a home will be decoded and displayed using the capabilities of current digital set-top boxes or like converters. Incoming VCS channels are displayed only if the viewer has subscribed to the service. The VCS operator will webcast each of the available channels over the Internet to each participating cable company. The channels are preferably webcast on a regular, scheduled basis and does not apply to VOD service. The participating cable company 450 receive the VCS feed 440, includes it in its broadband stream, and distributes the content to its subscribers. At participating homes, the set-top box will generate for digital television 470 display VCS screens such as shown in the example screen display of FIG. 7. The VCS viewer will be able to switch among the available VCS channels or select the VOD or, e-commerce options. These options are labeled as “Interactive Requests” 460 in FIG. 6. Specifically, these requests actually flow back up the physical cabling to a branching point offered by the cable company. At that point, the request will flow to the WWW 470 and, may trigger a standard, secure e-commerce transaction. Alternately, the request may be for VOD service as stored by VCS—essentially in the same locations that store the regularly broadcast VCS channels.

With further regard to the viewer interactivity enabled by the VCS system, VCS programming content presented to cable television viewers may include interactive video. This interactive experience enables the viewer to link to special sites on the WWW and to conduct e-commerce. Very importantly, VCS is viewed using a standard television set and requires only a standard remote control by which a viewer may intuitively manipulate to perform interactive functions. That is, no personal computer is required and no computer experience is necessary to benefit from the experiences and benefits offered by VCS.

VCS is a solution for merging mature technologies—WWW and television—to solve multiple business problems. The WWW has proven the ability to establish large consumer databases and enable interactive commerce. However, growth of e-commerce is hampered by issues that include: ease of use, complexity, and privacy. Cable television further has successfully expanded to reach the majority of homes. However, presently cable television is challenged by an overabundance of potential content and the difficulty in understanding the impact of advertising in a viewing environment diluted by hundreds of channels. Thus, VCS is a specially crafted form of interactive television. Generally, interactive television gives users the power to seek information on the WWW and to conduct e-commerce. VCS literally channels viewers to specific parts of the WWW where they can view “standardseeming” but specifically targeted television channels.

From the perspective of the end user, the cable television viewer, VCS provides a very simple, easy to navigate format. More importantly, VCS channels offer full, normal video content—not the reduced quality video typically seen on personal computers viewing video downloaded from the WWW. FIG. 7 depicts an exemplary VCS screen 600 presented on a digital television 610 or like television receiver. As shown in FIG. 7, the video content 620 dominates the screen 600 however, two rows of icons 625 are provided to enable easy, yet powerful navigation and include: a row 630 that permits switching among the VCS channels; and a row 640 top row having selectable buttons offering content specific to the channel and the program currently shown on that channel. With respect to VCS channels, the available channels a viewer may select from are packaged by VCS. Each of the available packages is, in effect, an entire cable system. VCS calls these cable systems “virtual” because they exist, not at some cable company, but on the Internet. With respect to the row 640 offering content specific to the channel and the program currently shown on that channel, selection of additional content is enabled including video on demand service or, conducting secure e-commerce. The video on demand, VOD, offered by this row of buttons may show advertising, supplemental material, or other content. Negotiations among content providers, advertisers, and VCS operators will determine the purpose of these buttons. In a preferred embodiment, the time “duration” for these buttons is a key element of VCS technology. Buttons will be able to change dynamically during the course of a specific program, enabling precision targeting of advertising material. Video select by using the top row 640 will be displayed using picture-in-picture, PIP, technology. In a preferred embodiment, programming of the top and bottom rows of buttons on the VCS screen—the functionality and links offered by these buttons—is prepared on a separate video channel. To enable display of the buttons on the viewer's screen, merging of these video streams is necessary. This merging will be individualized for technical infrastructure of each cable system offering VCS.

The VCS and business infrastructure according to the present invention have therefore been thoroughly demonstrated in the above descriptions and in the drawings of FIGS. 1-7. It should be emphasized that beyond using current technology, the VCS infrastructure may include specific value-added features and processes including: an EasyScreen™ format for display of primary content and navigation; a VirtualDistibutor™ comprising a software system enabling the appropriate merging of primary content and commercials plus scheduled webcasting to each cable system; and, CompleteTrack™, a custom software system tracking the distribution of programs, channels and advertising plus the interactive requests generated by each viewer. Lastly, the VCS itself represents a unique process for aggregating and distributing video material in an interactive environment.

While several embodiments of the invention, together with modifications thereof, have been described in detail herein and illustrated in the accompanying drawings, it will be evident that various further modifications are possible without departing from the scope of the invention. Nothing in the above specification is intended to limit the invention more narrowly than the appended claims. The examples given are intended only to be illustrative rather than exclusive.

Having thus described our invention, what we claim as new, and desire to secure by Letters Patent is:

1. A method for creating and distributing virtual channels of digital video content, the method comprising the steps of:
a) acquiring digital video content from one or more sources;
b) storing said digital video content into a database storage device;
c) selecting digital video content and grouping said selected digital video content to form virtual specialty channels, each virtual specialty channel having content customized for a particular viewer base, said virtual specialty channels being stored in said database storage device;
wherein said database storage device is accessible by a distributor over a public communications network, said distributor capable receiving virtual specialty channels over said public network and distributing one or more said virtual specialty channels to individual viewers over a broadband communications channel.

2. The method of claim 1, wherein said public communications network includes the Internet.

3. The selecting said video content method of claim 2, wherein said grouping of selected digital video content includes the step of scheduling selected digital video content programming for said virtual channel.

4. The method of claim 1, further including the steps of:
receiving interactive requests for digital video content from viewers over said public communications network; and,
processing history of received viewer requests to profile viewers and characterize video content; and,
utilizing said profile and characterizations as a basis for said selecting.

5. The method of claim 1, wherein said database storage device includes an object-oriented database with said digital video content comprising objects, said method including interactive system enabling user selection of objects for a virtual channel.

6. The method of claim 5, wherein said steps of selecting digital video content and scheduling includes selecting and scheduling secondary video content for a virtual channel.

7. The method of claim 3, wherein said digital video content includes associated metadata characterizing said video content, said selecting step further comprising the step of: searching said database storage device for like digital video content on the basis of said metadata.

8. The method of claim 7, wherein said metadata includes data comprising: textual description of content and, terms and conditions for use.

9. The method of claim 7, wherein said metadata includes data comprising legal and contractual documentation associated with said video content.

10. The method of claim 7, wherein said selecting and scheduling of digital video content for said virtual channel is performed by a visually interactive tool.

11. The method of claim 7, wherein said metadata includes business rules embedded therein indicating possible programming constraints, said selecting and scheduling step including implementing said business rules when forming said virtual channel.

12. The method of claim 6, wherein said secondary content includes advertisements.

13. The method of claim 2, wherein said acquiring step includes the step of:
inserting one or more timeline tags into primary program material of said digital video content, said timeline tags indicating potential placement of additional content for subsequent integration with said primary program content.

14. The method of claim 13, wherein said additional content to be integrated with said primary program content includes content enabling viewer interactivity including tags for enabling viewer video-on-demand requests.

15. The method of claim 13, wherein said additional content to be integrated with said primary program content includes content enabling viewer interactivity including tags for enabling an e-commerce transaction over said public communications network.

16. The method of claim 7, wherein said acquiring step a) further includes the step of generating additional keywords for use as metadata for facilitating searching of said database storage.

17. The method of claim 13, further comprising the steps of:
grouping a plurality of channels into a virtual cable system (VCS) including virtual channels to be distributed over said Internet, said virtual cable system being stored in said database; and,
webcasting a virtual cable system as a multiplexed signal to said distributor over said Internet.

18. The method of claim 17, wherein prior to webcasting said virtual cable signal, the step of performing a global digital merge where secondary content is added to primary program material of said digital video content in said virtual cable system.

19. The method of claim 17, further including the steps of
receiving said multiplexed signal;
demultiplexing said signal to extract said one or more virtual channels; and
performing a local global digital merge of content with the primary program material of said digital video content in said virtual channels.

20. The method of claim 19, wherein after said local merging the steps of:
re-multiplexing said one or more virtual channels of said VCS; and,
distributing one or more VCS channels to said viewer over a broadband channel for receipt by a viewer.

21. The method of claim 19, wherein said content includes interactive content in the form of user selectable links broadcast with said digital video content and that further enables a viewer to conduct an e-commerce transaction over said Internet via a set top box.

22. A system for creating and distributing virtual channels of digital video content, the system comprising:
means for receiving digital video content;
database storage means for storing digital video content, including said digitized analog video content;
means for selecting digital video content and grouping selected digital video content into virtual specialty channels, each virtual specialty channel having content customized for a particular viewer base, said virtual specialty channels being stored in said database storage means; and,
means for communicating said virtual specialty channels over a public communications network for receipt by a distributor entity, said distributor entity subsequently broadcasting said one or more said virtual specialty channels to individual viewers over a broadband communications channel.

23. The system of claim 22, wherein said public communications network includes the Internet.

24. The system of claim 23, further including means for scheduling selected digital video content programming for a virtual channel.

25. The system of claim 22, further including:
means for receiving interactive requests for digital video content from viewers over said public communications network; and,
an computer processing device for processing a history of received viewer requests in order to profile viewers and characterize video content; wherein said profile and characterizations are utilized as a basis for said selecting and scheduling means.

26. The system of claim 24, wherein said database storage means comprises an object-oriented database with said digital video content comprising objects, said system further including interactive means for enabling user selection of objects for said virtual channel.

27. The system of claim 26, wherein said digital video content includes secondary video content for said virtual channel.

28. The system of claim 24, wherein said digital video content includes associated metadata characterizing said video content, said selecting means further comprising means for searching said database storage device for like digital video content on the basis of said metadata.

29. The system of claim 28, wherein said metadata includes data comprising: textual description of content and, terms and conditions for use.

30. The system of claim 28, wherein said metadata includes data comprising legal and contractual documentation associated with said video content.

31. The system of claim 28, further including a visually interactive tool for enabling said selecting and scheduling of digital video content for said virtual channel.

32. The system method of claim 28, wherein said metadata includes business rules embedded therein indicating possible programming constraints, said selecting and scheduling step including implementing said business rules when forming said virtual channel.

33. The system of claim 27, wherein said secondary content includes advertisements.

34. The system of claim 23, further including means for inserting one or more timeline tags into primary program material of said digital video content, said timeline tags indicating potential placement of additional content for subsequent integration with said primary program content.

35. The system of claim 34, wherein said additional content to be integrated with said primary program content includes content enabling viewer interactivity including tags for enabling viewer video-on-demand requests.

36. The system of claim 34, wherein said additional content to be integrated with said primary program content includes content enabling viewer interactivity including tags for enabling an e-commerce transaction over said public communications network.

37. The system of claim 29, wherein said acquiring step a) further includes the step of generating additional keywords for use as metadata for facilitating searching of said database storage.

38. The system of claim 34, further comprising:
means for bundling a plurality of channels into a virtual cable system (VCS) including virtual channels to be distributed over said Internet, said virtual cable system being stored in said database means; and,
means for webcasting a virtual cable system as a multiplexed signal to said distributor over said Internet.

39. The system of claim 38, further including means for digitally merging secondary content with primary program material of said digital video content in said virtual cable system, said global merging being performed prior to said webcasting.

40. The system of claim 38, further including the steps of
means for receiving said multiplexed signal;
means for demultiplexing said signal to extract said one or more virtual channels; and
means for performing a local global digital merge of content with the primary program material of said digital video content in said virtual channels.

41. The system of claim 40, further including:
means for re-multiplexing said one or more virtual channels of said VCS; and,
means for distributing one or more VCS channels to said viewer over a broadband channel for receipt by a viewer.

42. The system of claim 40, wherein said content includes interactive content in the form of user selectable links broadcast with said digital video content and that further enables a viewer to conduct an e-commerce transaction over said Internet via a set top box.

43. A method for increasing user interactivity with cable television system programming comprising channels of digital video content, the method comprising:
enabling a first entity to acquiring digital video content from a plurality of content providers, select and schedule said video content for subsequent distribution as a virtual specialty channel;
inserting tags in said digital video content enabling subsequent viewer interactivity;
bundling collections of channels into one or more virtual cable systems and storing said virtual cable systems in a memory storage means connected to a public communications network;
webcasting one or more virtual cable systems to a second entity over said public communications network,
said second entity distributing said virtual cable systems to subscribing viewers over a broadband communications channel for receipt by a viewer television device, said subscribing viewers receiving digital video content via a control device associated with said television device and initiating display of said content via a display means;
enabling said control device to provide on-screen link on said display means corresponding to said inserted interactive tags, said on-screen links selectable by viewers for initiating interactivity with a third entity over said public communications network; and,
forwarding viewer requests from said control device over said public communications network to said third entity for interaction therewith.

44. The method as claimed in claim 43, wherein said viewer requests include requests for conducting e-commerce transactions.

45. The method as claimed in claim 43, wherein said viewer requests include video-on-demand requests.

46. The method as claimed in claim 43, wherein said inserting interactive tags in said digital video content enabling subsequent viewer interactivity includes providing global level merging of advertising content and interactive links with said video content, said first level of merging performed by said first entity.

47. The method as claimed in claim 46, wherein said inserting interactive tags in said digital video content enabling subsequent viewer interactivity includes providing local level merging of advertising content and interactive links with said video content, said second level of merging being performed by said second entity.

48. A virtual cable system comprising:
means for acquiring digital video content from a plurality of content providers,
interactive means for inserting tags in said digital video content enabling subsequent viewer interactivity;
means for selecting and scheduling said video content for subsequent distribution as a virtual specialty channel, said selecting and scheduling means further including means for bundling collections of channels into one or more virtual cable systems;
memory means for storing said virtual cable systems, said memory storage means connected to a public communications network;
means for webcasting one or more virtual cable systems to a second entity over said public communications network,
means provided by said second entity for distributing said virtual cable systems to subscribing viewers over a broadband communications channel for receipt by a viewer television display device;
a control device associated with said viewer television display device for initiating display of said content;
means provided by said control device for generating on-screen links for corresponding to said inserted tags, said on-screen links selectable by viewers for initiating interactivity with a third entity over said public communications network; and,
back-channel communication means for forwarding viewer requests from said control device over said public communications network to said third entity for interaction therewith.

49. The virtual cable system as claimed in claim 48, wherein said third entity includes a server device connected to said public communications network, said server device comprising functionality for conducting e-commerce transaction between said third entity and a requesting viewer.
